(19) United States
(12) Patent Application Publication
(10) Pub. No.: US 2023/0104992 A1
(43) Pub. Date: Apr. 6, 2023

(54) SPAD SENSOR ARRAY CONFIGURED TO OUTPUT COLOR AND DEPTH INFORMATION

(71) Applicant: GM Cruise Holdings LLC, San Francisco, CA (US)

(72) Inventors: Shane McGuire, Redwood City, CA (US); Joseph Matthew Robbins, Oakland, CA (US); Boyang Zhang, San Jose, CA (US)

(21) Appl. No.: 17/493,446

(22) Filed: Oct. 4, 2021

(51) Int. Cl. G01J 3/51; G01S 7/481; G02B 5/20; G01J 3/46; G01S 17/08

(52) U.S. Cl. CPC G01J 3/51; G01S 7/4816; G02B 5/208; G01J 3/463; G01S 17/08

(57) ABSTRACT

Described herein are various technologies pertaining to a sensor system for an autonomous vehicle (AV) that includes a single photon accelerated diode (SPAD) array. The SPAD array includes several pixels. A filter layer is arranged proximate the several pixels, where the filter layer includes color filter portions and unfiltered portions that are respectively aligned with first pixels of the SPAD array and second pixels of the SPAD array. A computing system determines both range to an object and information pertaining to color of the object based upon values read out from the pixels of the SPAD array.

### BACKGROUND

An autonomous vehicle is a motorized vehicle that can operate without a human driver. Because the autonomous vehicle does not have a human driver, the autonomous vehicle relies on outputs of a plurality of sensors to autonomously navigate about roadways. Conventionally, autonomous vehicles rely on a first sensor to determine distance of objects from the autonomous vehicle (such as a LIDAR sensor) and a second separate sensor to determine colors in the external environment (such as a color camera). However, having to install and operate two separate sensors is costly from a hardware perspective as well as from a computational perspective, because the separate data from the separate sensors must either be fused or processed independently, whereupon being processed independently the resultant data must be subsequently correlated.

### SUMMARY

The following is a brief summary of subject matter that is described in greater detail herein. This summary is not intended to be limiting as to scope of the claims.

Described herein are various technologies pertaining to a sensor system for an autonomous vehicle (AV), where the sensor system is configured to simultaneously determine range information for a scene and color information for the scene. With more specificity, the sensor system includes a receiver that receives an electromagnetic signal from the external environment of the autonomous vehicle, where the electromagnetic signal corresponds to a transmitted electromagnetic signal (e.g., by a transmitter on the autonomous vehicle) that has been reflected by an object in the external environment. The receiver includes a sensor with an array of pixels, where first pixels in the array have color filters applied thereto and second pixels in the array have no filters applied thereto.

The color filters are configured to allow electromagnetic radiation of first wavelengths in the visible spectrum to pass therethrough and reach the underlying pixel (e.g., where the first wavelengths correspond to a first color) while preventing electromagnetic radiation of second wavelengths in the visible spectrum from passing therethrough and reaching the underlying pixel. For instance, the color filters can be the same, such that the color filters allow light of the same color(s) to pass through while filtering out other colors. In a specific example, the color filters are red filters, such that red light is able to pass through the filters to underlying pixels while light of other colors is prevented from passing through the filters.

Conversely, the second pixels do not have color filters corresponding thereto, such that electromagnetic radiation having wavelengths corresponding to the color red as well as other colors can be detected by the pixels. The sensor array (including the first and second pixels referenced above) generates sensor data that is used to simultaneously compute distance to an object and color of the object in the external environment. More particularly, the sensor system can be a single photon avalanche diode (SPAD) sensor system, and the pixels can be SPAD pixels. Distance between the sensor system and the object is computed based upon values read from the first and second pixels, while color of the object can be determined by comparing values of the first pixels with values of the second pixels.

In one embodiment, the pixels are configured to detect photons with infrared wavelengths. In another embodiment, the sensor system includes pixels that have multiple layers, where a first layer of the pixels is configured to detect photons having a first wavelength while photons of a second wavelength pass therethrough, and a second layer of the pixels (immediately beneath the first layer) is configured to detect photons having the second wavelength. By using multi-layer pixels, the sensor system of the AV can detect multiple different wavelengths of electromagnetic radiation, such as wavelengths in the infrared spectrum and wavelengths in the visible spectrum.

The above-described technologies present various advantages over conventional sensor systems for AVs. Unlike the conventional approach of using multiple separate sensors to detect range and color, the above-described technologies employ a pattern of filters to allow a conventional ranging sensor system to additionally provide information regarding color. Moreover, the above-described technologies allow a single receiver to be used to detect multiple different wavelengths.

The above summary presents a simplified summary in order to provide a basic understanding of some aspects of the systems and/or methods discussed herein. This summary is not an extensive overview of the systems and/or methods discussed herein. It is not intended to identify key/critical elements or to delineate the scope of such systems and/or methods. Its sole purpose is to present some concepts in a simplified form as a prelude to the more detailed description that is presented later.

### BRIEF DESCRIPTION OF THE DRAWINGS

FIG. 1 illustrates a block diagram of a sensor system for an autonomous vehicle (AV) that uses a single receiver to determine distance and color.

FIG. 2 illustrates an exemplary receiver.

FIG. 3 illustrates another exemplary receiver.

FIG. 4 is a flow diagram that illustrates an exemplary methodology for forming a sensor system for an AV that uses a single receiver to determine distance and color.

FIG. 5 is a flow diagram that illustrates an exemplary methodology executed by a computing system for using lidar data.

FIG. 6 illustrates an exemplary computing device.

### DETAILED DESCRIPTION

Various technologies pertaining to a sensor system for an autonomous vehicle (AV) that uses one receiver in a sensor system for simultaneously identifying distance to an object and color of the object are now described with reference to the drawings, wherein like reference numerals are used to refer to like elements throughout. In the following description, for purposes of explanation, numerous specific details are set forth in order to provide a thorough understanding of one or more aspects. It may be evident, however, that such aspect(s) may be practiced without these specific details. In other instances, well-known structures and devices are shown in block diagram form in order to facilitate describing one or more aspects. Further, it is to be understood that functionality that is described as being carried out by certain system components may be performed by multiple components. Similarly, for instance, a component may be configured to perform functionality that is described as being carried out by multiple components.

Moreover, the term “or” is intended to mean an inclusive “or” rather than an exclusive “or.” That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B. In addition, the articles “a” and “an” as used in this application and the appended claims should generally be construed to mean “one or more” unless specified otherwise or clear from the context to be directed to a singular form.

Further, as used herein, the terms “component”, “system”, and “module” are intended to encompass computer-readable data storage that is configured with computer-executable instructions that cause certain functionality to be performed when executed by a processor. The computer-executable instructions may include a routine, a function, or the like. It is also to be understood that a component or system may be localized on a single device or distributed across several devices. Further, as used herein, the term “exemplary” is intended to mean serving as an illustration or example of something and is not intended to indicate a preference.

Disclosed are various technologies that generally relate to a sensor system for an AV (e.g., a fully autonomous, level 5 AV), where data generated by the sensor system can be used to simultaneously determine distance between the sensor system and an object in an external environment of the AV and information that is indicative of color of the object. In an example, the sensor system includes a single-photon avalanche diode (SPAD) array, which includes an array of pixels. First pixels in the array of pixels are filtered, while second pixels in the array of pixels are unfiltered. For instance, the first pixels have red filters applied thereto, such that photons having a wavelength that correspond to the color red (and photons having infrared wavelengths) pass through the filter. Pursuant to an example, a filter layer is applied over the pixels, where the filter layer is patterned with red filter portions and clear portions. The filter layer is aligned with the pixels such that red filter portions are positioned above the first pixels while clear portions are positioned above the second pixels. In another example, the filter layer can include voids that are etched out, such that red filter portions are aligned with the first pixels and voids are aligned with the second pixels.

The sensor system further includes a transmitter that emits electromagnetic radiation into an external environment of the AV, where at least some of the electromagnetic radiation reflects from an object and back towards the sensor system (and the array of pixels). The red filter portions allow photons having infrared (IR) and red wavelengths to pass therethrough to the underlying first pixels, photons having wavelengths in the IR spectrum and the visible spectrum (with wavelengths shorter than the color red) can reach the underlying second pixels. The pattern can be any suitable pattern, such as a checkerboard-type pattern. In another example, every fourth pixel in the SPAD array can have a color filter applied thereto. Other patterns are contemplated.

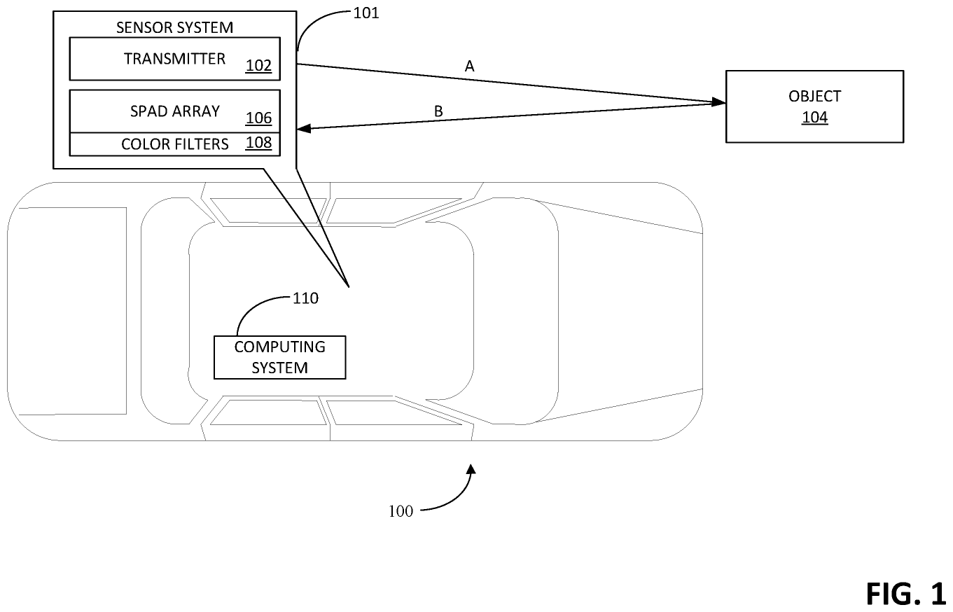

With reference now to FIG. 1, illustrated is an AV 100 having a sensor system 101, where the sensor system 101 is configured to generate data that is indicative of both: 1) color of one or more objects in an external environment of the AV 100; and 2) distance between the sensor system 101 and the one or more objects. Therefore, in contrast to conventional sensor systems for AVs that rely on one sensor for determining distance to an object and another sensor for determining color of the object, the sensor system 101 described herein uses a single sensor array to determine both distance and information that is indicative of color.

In one embodiment, illustrated in FIG. 1, the sensor system 101 includes a transmitter 102 that includes a light source that is configured to illuminate at least a portion of an external environment of the AV 100 with electromagnetic radiation. In an example, the sensor system 101 can be a LIDAR system, and the transmitter 102 can be a scanning transmitter or a rotary transmitter. At least some of the electromagnetic radiation propagates in an external environment of the AV 100, such as along line A. At least some of the electromagnetic radiation emitted by the transmitter 102 can reflect off of an object 104 (e.g., a telephone pole, a wall, a pedestrian, another vehicle, etc.) in the external environment of the AV. At least some of the reflected electromagnetic radiation can be directed back towards the sensor system 101, such as along line B. The transmitter 102 includes a light source configured to illuminate at least a portion of the external environment of the AV 100.

The sensor system 101 additionally includes an array of single-photon avalanche diode (SPAD) pixels, referred to herein as a SPAD array 106. The SPAD array 106 includes pixels that are configured to detect photons having wavelengths in the visible spectrum and the IR spectrum. As will be described in greater detail below, the pixels of the SPAD array 106 may be multi-layered pixels, such that each pixel in the SPAD array 106 includes: 1) a first layer that is configured to detect photons having wavelengths in a first range; and 2) a second layer (immediately beneath the first layer) that is configured to detect photons having wavelengths in a second range, where the first range and second range are non-overlapping. In such an example, photons having wavelengths in the second range are able to pass through the first layer of the pixel (e.g., such photons do not interact with material of the first layer of the pixel).

In addition, the sensor system 101 includes color filters 108 that are arranged in a pattern relative to pixels in the SPAD array 106. In an example, the color filters 108 may be red filters, such that photons having wavelengths below 620 nm are filtered and prevented from reaching underlying pixels of the SPAD array 106. Red filters are advantageous in that the IR spectrum is adjacent to red in the visible spectrum. The color filters are aligned with first pixels in the SPAD array 106, while second pixels in the SPAD array 108 have no color filter corresponding thereto. Hence, a photon having a wavelength that is shorter than 620 nm can reach a pixel in the second pixels. Pursuant to an example, one pixel out of every four pixels has a color filter applied thereto. In another example, one filter out of every six pixels has a color filter applied thereto. Further, the pattern may be any suitable pattern, such as a checkerboard-like pattern, a spiral pattern, etc.

In an example, the color filters 108 can be included in a filter layer that is aligned with pixels in the SPAD array 106. The filter layer, in an example, includes color filter portions that are aligned with the first pixels of the SPAD array 106, and includes unfiltered (e.g., clear) portions that are aligned with the second pixels of the SPAD array 106. In another embodiment, the filter layer includes color filter portions that are aligned with the first pixels of the SPAD array 106, and includes voids that are aligned with the second pixels of the SPAD array 106.

The AV 100 further includes a computing system 110 that is in communication with the sensor system 101, where the computing system 110 is configured to compute distance between the sensor system 101 and the object 104 based upon data read from the SPAD array 106. The computing system 110 is further configured to output an indication of color of the object 104 (e.g., red or not red) based upon the data read from the SPAD array 106. With more particularity, the computing system 110 can compare data read from the first pixels with data read from the second pixels to obtain some color information about the object; when the data read from the first pixels is approximately the same as the data read from the second pixels, the computing system 110 can determine that the object is a shade of red. In contrast, when the data read from the first pixels is different from the data read from the second pixels, the computing system 110 can determine that the object is not a shade of red.

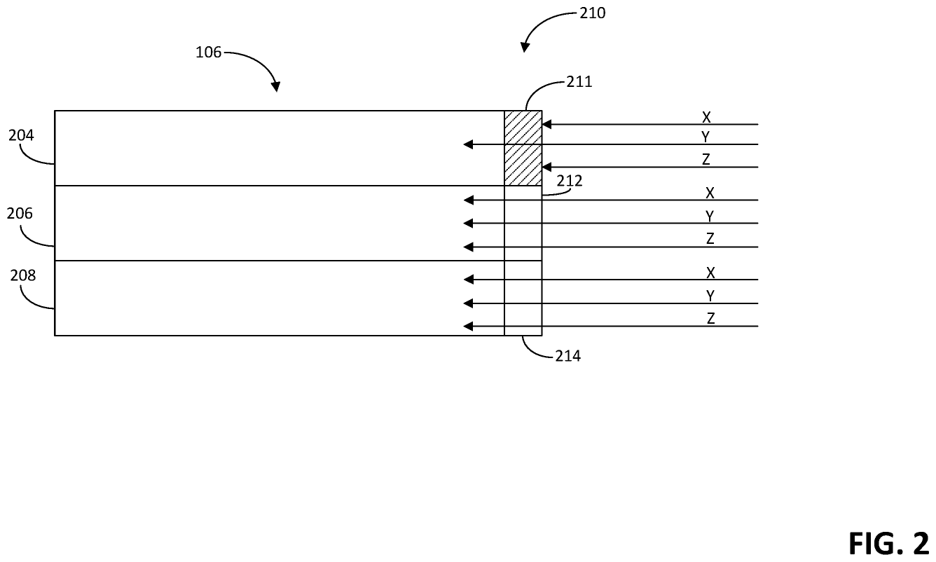

Turning now to FIG. 2, illustrated is an embodiment of the SPAD array 106 and corresponding color filters 108. In the embodiment depicted in FIG. 2, the color filters 108 are placed adjacent to pixels in the SPAD array 106; it is to be understood, however, that a gap may exist between the color filters 108 and the pixels of the SPAD array 106. The SPAD array 106 includes an array of pixels, namely, a first pixel 204, a second pixel 206, and a third pixel 208 (collectively referred to herein as pixels 204-208).

As mentioned above, the color filters 108 can include a filter layer 210 that includes color filter portions that are aligned with the first pixels of the SPAD array 106 and unfiltered portions that are aligned with the second pixels of the SPAD array 206. In the example shown in FIG. 2, the filter layer 210 includes a filter portion 211 that is aligned with the first pixel 204, a first unfiltered portion 212 that is aligned with the second pixel 206, and a third unfiltered portion 214 that is aligned with the third pixel 208.

In the illustrated embodiment, photons having three different wavelengths (X, Y, and Z) are travelling towards the SPAD array 106. Pursuant to an example, wavelength X is 400 nm, wavelength Y is 900 nm, and wavelength Z is 525 nm. The color filter portion 211 that is aligned with the first pixel 204 is configured to filter photons with wavelengths less than 620 nm. Therefore, the color filter portion 211 prevents photons having wavelengths of X and Z from passing therethrough and interacting with material of the first pixel 204; however, photons having wavelength Y are able to pass through the filter portion 211 and can be detected by the first pixel 204. In contrast, the second pixel 206 and third pixel 208 have unfiltered portions aligned therewith, and thus photons having wavelengths of X, Y, and Z are able to reach the second pixel 206 and the third pixel 208.

In a first example, when the object 104 is violet, photons with wavelength X travel towards the SPAD array 106 from the object 104. The filter portion 211 prevents the photons from passing therethrough and reaching the first pixel 204; however, due to the second pixel 206 and third pixel 208 having unfiltered portions aligned therewith, photons of wavelength X reach such pixels. Therefore, when data is readout from the pixels 204-208, the computing system 110 (based upon time of flight) can compute range to the object 104. Further, based upon a comparison between a value read from the first pixel 204 and values read from the pixels 206-208, the computing system 110 can determine that the object 104 is not red in color.

In a second example, when the object 104 is red, photons with wavelength Y travel towards the SPAD array 106 from the object 104. Due to the wavelength of the photons, such photon pass through the filter portion 211 and reach the first pixel 204. Similarly, as the second pixel 206 and third pixel 208 have unfiltered portions aligned therewith, photons of wavelength Y reach such pixels as well. Therefore, when data is readout from the pixels 204-208, the computing system 110 (based upon time of flight) can compute range to the object 104. Further, based upon a comparison between a value read from the first pixel 204 and values read from the pixels 206-208, the computing system 110 can determine that the object 104 is red in color.

As briefly mentioned above, the pixels 204-208 may be multi-layer pixels, where, for example, the first layer is configured to detect photons having wavelengths in the visible spectrum and the second layer is configured to detect photons having wavelengths in the IR spectrum.

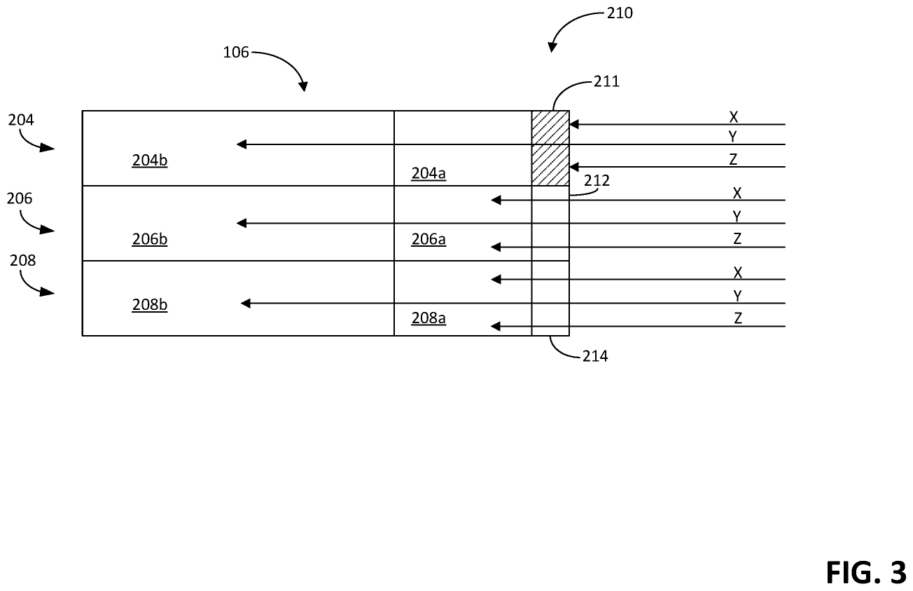

Turning now to FIG. 3, another embodiment of the SPAD array 106 is depicted, where pixels of the SPAD array 106 are multi-layered. Therefore, the first pixel 204 includes a first layer 204a and a second layer 204b, the second pixel 206 includes a first layer 206a and a second layer 206b, and the third pixel 208 includes a first pixel layer 208a and a second pixel layer 208b.

The first layers 204a, 206a, and 208a of the pixels 204-208, respectively, are composed of a first material that interacts with photons within a first range of wavelengths (e.g., wavelengths in the visible spectrum); however, photons in a second range of wavelengths (e.g., wavelengths in the IR spectrum) do not interact with the first material and therefore pass through the first layers 204a, 206a, and 208a of the pixels 204-208. The second layers 204b, 206b, and 208b of the pixels 204-208, respectively, are composed of a second material that interacts with photons within the second range of wavelengths. The different layers of the pixels can be read out separately.

Pursuant to an example, the object 104 can be green in color, and thus photons of wavelength Z are directed towards the SPAD array 106. Moreover, the transmitter 102 may illuminate the object 104 with IR radiation, and therefore photons of wavelength Y reflect from the object 104 and are directed towards the SPAD array 106. The filter portion 211 filters photons of wavelength Z, and thus the photons of wavelength Z do not reach the first layer 204a of the first pixel 204 (or the second layer 204b of the first pixel 204). Contrarily, photons of wavelength Z pass through the unfiltered portion aligned with the second and third pixels 206 and 208. The photons interact with the first material of the first layers 206a and 208a, and therefore values read out from the first layers 204a-208a indicate that the color of the object 104 is not red. Meanwhile, photons of the wavelength Y pass through the filter portion 211 of the first pixel 204, pass through the first layer 204a of the first pixel 204, and interact with the second material of the second layer 204b of the first pixel 204. In addition, photons of wavelength Y reach the first layers 206a, 208a of the pixels 206 and 208, pass through such layers, and interact with the second material of the second layers 206b and 208b of the pixels 206 and 208, respectively. Values of the second layers 204b-208b can be read out, and the computing system 110 determines range to the object 104 based upon the values read out from the second layers 204b-208b.

It can be ascertained that different pixels can have different filter portions applied thereto, and that a pixel can include more than two layers. For example, a pixel can include a first layer that is composed of a first material that interacts with photons having a first range of wavelengths, a second layer that is composed of a second material that interacts with photons having a second range of wavelengths, a third layer that is composed of a third material that interacts with photons having a third range of wavelengths, a fourth layer that is composed of a fourth material that interacts with photons having a fourth range of wavelengths, etc. In addition, different color filters can be applied to pixels, such that a first color filter filters out photons having a first range of wavelengths, a second color filter filters out photons having a second range of wavelengths, and so forth. Any suitable combination of color filters and layers can be employed in connection with determining both range and color information for

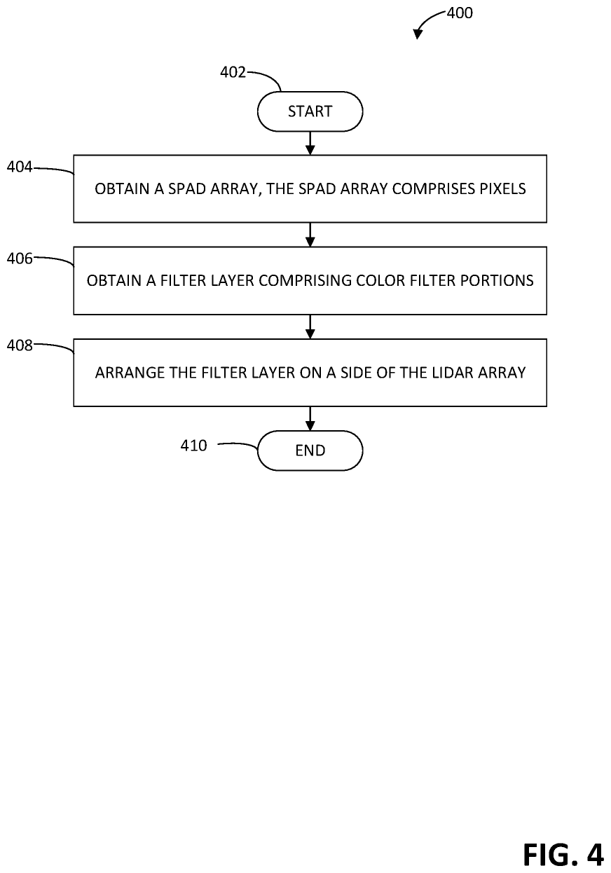

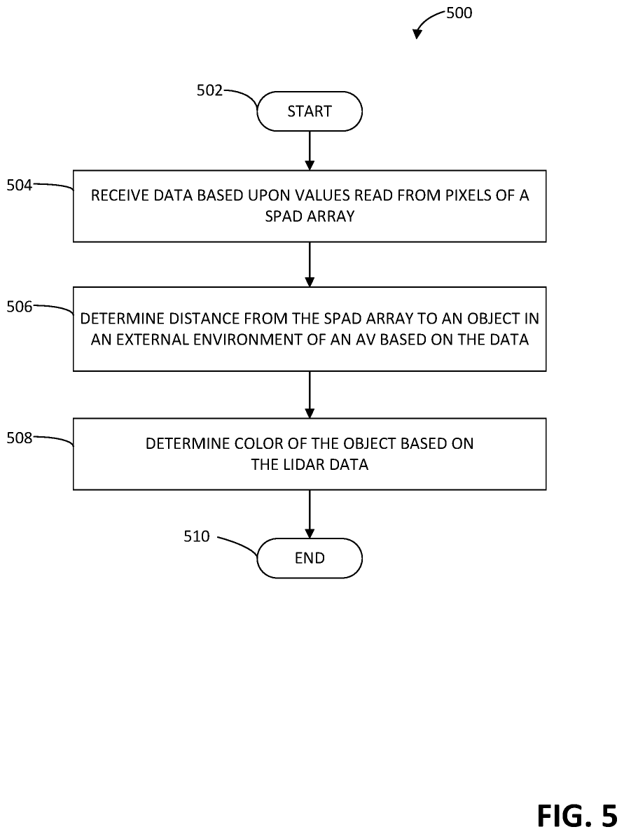

FIG. 4 illustrates an exemplary methodology 400 for forming a sensor system for an autonomous vehicle. FIG. 5 illustrates an exemplary methodology 500 for simultaneously determining information pertaining to distance and color of an object based on LIDAR data. While the methodologies 400 and 500 are shown as being a series of acts that are performed in a sequence, it is to be understood and appreciated that the methodologies are not limited by the order of the sequence. For example, some acts can occur in a different order than what is described herein. In addition, an act can occur concurrently with another act. Further, in some instances, not all acts may be required to implement a methodology described herein.

Moreover, the acts described herein may be computer-executable instructions that can be implemented by one or more processors and/or stored on a computer-readable medium or media. The computer-executable instructions can include a routine, a sub-routine, programs, a thread of execution, and/or the like. Still further, results of acts of the methodologies can be stored in a computer-readable medium displayed on a display device, and/or the like.

Referring now to FIG. 4, the methodology 400 begins at 402, and at 404, a SPAD array is obtained, wherein the SPAD array includes an array of pixels. At 406, a filter layer that includes color filter portions and unfiltered portions is obtained. At 408, the filter layer is arranged relative to the SPAD array such that first pixels in the SPAD array are aligned with color filter portions and second pixels in the SPAD array are aligned with unfiltered portions. The SPAD array is configured to receive electromagnetic radiation from an external environment of an AV, where the electromagnetic radiation has reflected off of an object in the environment. The color filter portions prevent photons having a range of wavelengths from passing therethrough and reaching the underlying first pixels, while photons having the range of wavelengths reach the second pixels by way of the unfiltered portions. The methodology 400 concludes at 410.

Now referring to FIG. 5, the methodology 500 for simultaneously determining information pertaining to distance and color of an object based on LIDAR data starts at 502, and at 504 data that is based upon values read out from pixels of a SPAD array is received. The data is generated in response to the pixels in the SPAD array detecting electromagnetic radiation in an external environment of an AV. A portion of the electromagnetic radiation corresponds to a transmitted electromagnetic signal that has reflected off of an object in the external environment of the AV. At 506, a distance from the SPAD array to the object in the external environment is determined based on the data. At 508, information pertaining to color of the object is determined based on the data. The distance and color information can be determined simultaneously based on the data. The methodology 500 concludes at 510.

Technologies relating to a sensor system of an AV that is configured to simultaneously determine range information for a scene and color information for the scene are described herein in accordance with the following examples.

(A1) In an aspect, a sensor system for an AV includes a SPAD array, wherein the SPAD array includes several pixels that are configured to detect photons having wavelengths within a range of wavelengths that have reflected from an object in an environment of the AV. The sensor system also includes a filter layer that includes color filter portions and unfiltered portions, where the color filter portions are aligned with first pixels in the several pixels of the SPAD array and the unfiltered portions are aligned with second pixels in the several pixels of the SPAD array. A computing system computes both a range to the object and information pertaining to a color of the object based upon values read out from the several pixels. Further, the computing system controls operation of a mechanical system of the AV based upon the range to the object and the information pertaining to the color of the object.

(A2) In some embodiments of the sensor system of (A1), the color filter portions prevent photons having a first range of wavelengths in the range of wavelengths from reaching the first pixels while allowing photons having a second range of wavelengths in the range of wavelengths to pass therethrough.

(A3) In some embodiments of at least one of the sensor system of (A1)-(A2), the color filter portions prevent photons below 620 nm from passing therethrough.

(A4) In some embodiments of the sensor system of at least one of (A1)-(A3), the sensor system is a LIDAR sensor system.

(A5) In some embodiments of the sensor system of at least one of (A1)-(A4), the sensor system also includes a transmitter that emits infrared electromagnetic radiation into the environment of the AV, where the pixels of the SPAD array are configured to detect photons having wavelengths in the infrared spectrum and wavelengths in the visible spectrum.

(A6) In some embodiments of the sensor system of at least one of (A1)-(A5), the computing system determines the information pertaining to the color of the object based upon a comparison between first values read out from the first pixels with second values read out from the second pixels.

(A7) In some embodiments of the sensor system of at least one of (A1)-(A6), the information pertaining to the color of the object is an indication as to whether or not the object is a shade of red.

(A8) In some embodiments of the sensor system of at least one of (A1)-(A7), the several pixels are multi-layer pixels, with each pixel in the several pixels having a first layer composed of a first material and a second layer composed of a second material, wherein the first layer is adjacent the second layer.

(A9) In some embodiments of the sensor system of (A8), the first layer is configured to absorb photons having wavelengths in a first range of wavelengths in the range of wavelengths, and the second layer is configured to absorb photons having wavelengths in a second range of wavelengths in the range of wavelengths, the first range of wavelengths being non-overlapping with the second range of wavelengths.

(A10) In some embodiments of the sensor system of (A9), the first layer is configured to allow the photons having wavelengths in the second range of wavelengths to pass therethrough, and further wherein the color filter portions are configured to allow the photons having wavelengths in the second range of wavelengths to pass therethrough.

(B1) In another aspect, a method for forming a sensor system for an autonomous vehicle includes providing a SPAD array, where the SPAD array includes several pixels that are configured to detect photons having wavelengths within a range of wavelengths that have reflected from an object in an environment of the AV. The method also includes arranging a filter layer relative to the SPAD array, the filter layer includes color filter portions and unfiltered portions. Arranging the filter layer relative to the SPAD array includes aligning the color filter portions with first pixels in the several pixels of the SPAD array. Arranging the filter layer relative to the SPAD array also includes aligning the unfiltered portions with second pixels in the several pixels of the SPAD array, wherein a computing system computes both a range to the object and information pertaining to a color of the object based upon values read out from the several pixels, and further wherein the computing system controls operation of a mechanical system of the AV based upon the range to the object and the information pertaining to the color of the object.

(B2) In some embodiments of the method of (B1), the color filter portions prevent photons having a first range of wavelengths in the range of wavelengths from reaching the first pixels while allowing photons having a second range of wavelengths in the range of wavelengths to pass therethrough.

(B3) In some embodiments of the method of at least one of (B1)-(B2), the color filter portions prevent photons below 620 nm from passing therethrough.

(B4) In some embodiments of the method of at least one of (B1)-(B3), the sensor system is a LIDAR sensor system.

(B5) In some embodiments of the method of at least one of (B1)-(B4), a transmitter emits infrared electromagnetic radiation into the environment of the AV, and the pixels of the SPAD array are configured to detect photons having wavelengths in the infrared spectrum and wavelengths in the visible spectrum.

(B6) In some embodiments of the method of at least one of (B1)-(B5), the computing system determines the information pertaining to the color of the object based upon a comparison between first values read out from the first pixels with second values read out from the second pixels.

(B7) In some embodiments of the method of at least one of (B1)-(B6), the information pertaining to the color of the object is an indication as to whether or not the object is a shade of red.

(B8) In some embodiments of the method of at least one of (B1)-(B7), the several pixels are multi-layer pixels, with each pixel in the several pixels having a first layer composed of a first material and a second layer composed of a second material, wherein the first layer is adjacent the second layer.

(B9) In some embodiments of the method of (B8), the first layer is configured to absorb photons having wavelengths in a first range of wavelengths in the range of wavelengths, and further wherein the second layer is configured to absorb photons having wavelengths in a second range of wavelengths in the range of wavelengths, the first range of wavelengths being non-overlapping with the second range of wavelengths.

(C1) In another aspect, an AV includes a mechanical system, a sensor system, and a computing system. The sensor system includes a SPAD array, where the SPAD array includes several pixels that are configured to detect photons having wavelengths within a range of wavelengths that have reflected from an object in an environment of the AV. The sensor system also includes a filter layer that includes color filter portions and unfiltered portions, where the color filter portions are aligned with first pixels in the several pixels of the SPAD array, the unfiltered portions are aligned with second pixels in the several pixels of the SPAD array. The computing system is operably coupled to the mechanical system and the sensor system. The computing system is configured to determine both a range to the object and information pertaining to a color of the object based upon values read out from the several pixels, and the computing system controls operation of the mechanical system based upon the range to the object and the information pertaining to the color of the object.

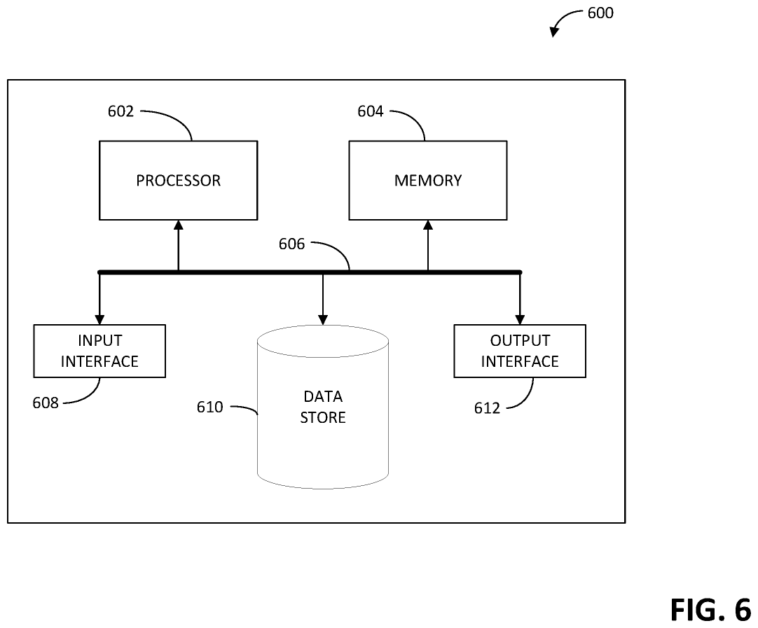

Referring now to FIG. 6, a high-level illustration of an exemplary computing device that can be used in accordance with the systems and methodologies disclosed herein is illustrated. For instance, the computing device 600 may be or include the computing system. The computing device 600 includes at least one processor 602 that executes instructions that are stored in a memory 604. The instructions may be, for instance, instructions for implementing functionality described as being carried out by one or more components discussed above or instructions for implementing one or more methods described above. The processor 602 may be a GPU, a plurality of GPUs, a CPU, a plurality of CPUs, a multi-core processor, etc. The processor 602 may access the memory 604 by way of a system bus 606. In addition to storing executable instructions, the memory 604 may also store color information, range information, etc.

The computing device 600 additionally includes a data store 610 that is accessible by the processor 602 by way of the system bus 606. The data store 610 may include executable instructions, images, data specifying characteristics of specific objects, etc. The computing device 600 also includes an input interface 608 that allows external devices to communicate with the computing device 600. For instance, the input interface 608 may be used to receive instructions from an external computer device, from a user, etc. The computing device 600 also includes an output interface 612 that interfaces the computing device 600 with one or more external devices. For example, the computing device 600 may display text, images, etc. by way of the output interface 612.

Additionally, while illustrated as a single system, it is to be understood that the computing device 600 may be a distributed system. Thus, for instance, several devices may be in communication by way of a network connection and may collectively perform tasks described as being performed by the computing device 600.

Various functions described herein can be implemented in hardware, software, or any combination thereof. If implemented in software, the functions can be stored on or transmitted over as one or more instructions or code on a computer-readable medium. Computer-readable media includes computer-readable storage media. A computer-readable storage media can be any available storage media that can be accessed by a computer. By way of example, and not limitation, such computer-readable storage media can comprise RAM, ROM, EEPROM, CD-ROM or other optical disk storage, magnetic disk storage or other magnetic storage devices, or any other medium that can be used to store desired program code in the form of instructions or data structures and that can be accessed by a computer. Disk and disc, as used herein, include compact disc (CD), laser disc, optical disc, digital versatile disc (DVD), floppy disk, and Blu-ray disc (BD), where disks usually reproduce data magnetically and discs usually reproduce data optically with lasers. Further, a propagated signal is not included within the scope of computer-readable storage media. Computer-readable media also includes communication media including any medium that facilitates transfer of a computer program from one place to another. A connection, for instance, can be a communication medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of communication medium. Combinations of the above should also be included within the scope of computer-readable media.

Alternatively, or in addition, the functionally described herein can be performed, at least in part, by one or more hardware logic components. For example, and without limitation, illustrative types of hardware logic components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), etc.

As described herein, one aspect of the present technology is the gathering and use of data available from various sources to improve quality and experience. The present disclosure contemplates that in some instances, this gathered data may include personal information. The present disclosure contemplates that the entities involved with such personal information respect and value privacy policies and practices.

What has been described above includes examples of one or more embodiments. It is, of course, not possible to describe every conceivable modification and alteration of the above devices or methodologies for purposes of describing the aforementioned aspects, but one of ordinary skill in the art can recognize that many further modifications and permutations of various aspects are possible. Accordingly, the described aspects are intended to embrace all such alterations, modifications, and variations that fall within the spirit and scope of the appended claims. Furthermore, to the extent that the term “includes” is used in either the details description or the claims, such term is intended to be inclusive in a manner similar to the term “comprising” as “comprising” is interpreted when employed as a transitional word in a claim.

What is claimed is:

1. A sensor system for an autonomous vehicle (AV), comprising:
a single photon accelerated diode (SPAD) array, wherein the SPAD array includes several pixels that are configured to detect photons having wavelengths within a range of wavelengths that have reflected from an object in an environment of the AV; and
a filter layer comprising color filter portions and unfiltered portions, wherein the color filter portions are aligned with first pixels in the several pixels of the SPAD array, the unfiltered portions are aligned with second pixels in the several pixels of the SPAD array, wherein a computing system computes both a range to the object and information pertaining to a color of the object based upon values read out from the several pixels, and further wherein the computing system controls operation of a mechanical system of the AV based upon the range to the object and the information pertaining to the color of the object.

2. The sensor system of claim 1, wherein the color filter portions prevent photons having a first range of wavelengths in the range of wavelengths from reaching the first pixels while allowing photons having a second range of wavelengths in the range of wavelengths to pass therethrough.

3. The sensor system of claim 2, wherein the color filter portions prevent photons below 620 nm from passing therethrough.

4. The sensor system of claim 1 being a LIDAR sensor system.

5. The sensor system of claim 1, further comprising a transmitter that emits infrared electromagnetic radiation into the environment of the AV, and further wherein the pixels of the SPAD array are configured to detect photons having wavelengths in the infrared spectrum and wavelengths in the visible spectrum.

6. The sensor system of claim 1, wherein the computing system determines the information pertaining to the color of the object based upon a comparison between first values read out from the first pixels with second values read out from the second pixels.

7. The sensor system of claim 1, wherein the information pertaining to the color of the object is an indication as to whether or not the object is a shade of red.

8. The sensor system of claim 1, wherein the several pixels are multi-layer pixels, with each pixel in the several pixels having a first layer composed of a first material and a second layer composed of a second material, wherein the first layer is adjacent the second layer.

9. The sensor system of claim 8, wherein the first layer is configured to absorb photons having wavelengths in a first range of wavelengths in the range of wavelengths, and further wherein the second layer is configured to absorb photons having wavelengths in a second range of wavelengths in the range of wavelengths, the first range of wavelengths being non-overlapping with the second range of wavelengths.

10. The sensor system of claim 9, wherein the first layer is configured to allow the photons having wavelengths in the second range of wavelengths to pass therethrough, and further wherein the color filter portions are configured to allow the photons having wavelengths in the second range of wavelengths to pass therethrough.

11. A method for forming a sensor system for an autonomous vehicle (AV), the method comprising:
providing a single photon accelerated diode (SPAD) array, wherein the SPAD array includes several pixels that are configured to detect photons having wavelengths within a range of wavelengths that have reflected from an object in an environment of the AV; and
arranging a filter layer relative to the SPAD array, the filter layer includes color filter portions and unfiltered portions, wherein arranging the filter layer relative to the SPAD array comprises:
aligning the color filter portions with first pixels in the several pixels of the SPAD array; and
aligning the unfiltered portions with second pixels in the several pixels of the SPAD array, wherein a computing system computes both a range to the object and information pertaining to a color of the object based upon values read out from the several pixels, and further wherein the computing system controls operation of a mechanical system of the AV based upon the range to the object and the information pertaining to the color of the object.

12. The method of claim 12, wherein the color filter portions prevent photons having a first range of wavelengths in the range of wavelengths from reaching the first pixels while allowing photons having a second range of wavelengths in the range of wavelengths to pass therethrough.

13. The method of claim 12, wherein the color filter portions prevent photons below 620 nm from passing therethrough.

14. The method of claim 11, wherein the sensor system is a LIDAR sensor system.

15. The method of claim 11, wherein a transmitter emits infrared electromagnetic radiation into the environment of the AV, and further wherein the pixels of the SPAD array are configured to detect photons having wavelengths in the infrared spectrum and wavelengths in the visible spectrum.

16. method of claim 11, wherein the computing system determines the information pertaining to the color of the object based upon a comparison between first values read out from the first pixels with second values read out from the second pixels.

17. The method of claim 11, wherein the information pertaining to the color of the object is an indication as to whether or not the object is a shade of red.

18. The method of claim 11, wherein the several pixels are multi-layer pixels, with each pixel in the several pixels having a first layer composed of a first material and a second layer composed of a second material, wherein the first layer is adjacent the second layer.

19. The method of claim 18, wherein the first layer is configured to absorb photons having wavelengths in a first range of wavelengths in the range of wavelengths, and further wherein the second layer is configured to absorb photons having wavelengths in a second range of wavelengths in the range of wavelengths, the first range of wavelengths being non-overlapping with the second range of wavelengths.

20. An autonomous vehicle (AV) comprising:
a mechanical system;
a sensor system comprising:
a single photon accelerated diode (SPAD) array, wherein the SPAD array includes several pixels that are configured to detect photons having wavelengths within a range of wavelengths that have reflected from an object in an environment of the AV; and
a filter layer comprising color filter portions and unfiltered portions, wherein the color filter portions are aligned with first pixels in the several pixels of the SPAD array, the unfiltered portions are aligned with second pixels in the several pixels of the SPAD array; and
a computing system that is operably coupled to the mechanical system and the sensor system, the computing system is configured to determine both a range to the object and information pertaining to a color of the object based upon values read out from the several pixels, and further wherein the computing system controls operation of the mechanical system based upon the range to the object and the information pertaining to the color of the object.
